(19) United States
(12) Patent Application Publication
(10) Pub. No.: US 2020/0386447 A1
(43) Pub. Date: Dec. 10, 2020

(54) Heat pump management of low-grade-heat in buildings

(71) Applicant: Lin-Shu Wang, Stony brook, NY (US)

(72) Inventor: Lin-Shu Wang, Stony brook, NY (US)

(21) Appl. No.: 16/432,060

(22) Filed: Jun. 5, 2019

(51) Int. Cl. F24S 20/60; F24F 1/68; F25B 30/02; F24S 90/00; F24F 5/00; F25B 41/04

(52) U.S. Cl. CPC F24S 20/60; F24F 1/68; F25B 30/02; F24F 2005/0064; F24F 5/005; F25B 41/046; F24S 90/00

(57) ABSTRACT

One embodiment of LMHPs, as shown in FIG. 10, is a multi-function, grid-interactive heat pump system by alternately charging/discharging thermal energy storage (40) as its heat pump source. The charging process maintains thermal stability to the source. The thermal stability of the source ensures high system performance, and this energy-storage-as-source and its effective use provide system operational versatility. Which takes the forms of availing the system-operation of dual heat sources (10 and 20) for heating application, demand-response management (48), grid-integrated water heating (46) as well as grid-integrated space heating and cooling (48). By transcending the limitations of individual, stand-alone, solar units and heat pump units, the grid-interactive heat pump system performs heating function better than all existing heat pump methods. LMHP principle is applicable to single-function, grid-interactive heat pump operation with similar benefits of high performance and demand-response management. Other embodiments are described and shown.

### BACKGROUND OF THE INVENTION

### Field of the Invention

THE invention pertains to the application of electric powered heat pumps for building cooling and heating with dual heat sources/heat reservoirs or with single air heat reservoir.

### Description of the Related Art

Sadi Carnot (1824) invented the idea of reversible machines, which can operate as a heat engine and, in opposite operational direction, operate as a heat pump. William Thomson in 1852 conceived the application of heat pumps for both heating and cooling of space. Electric powered heat pump was instantly successful in cooling application and it, after its 1852 conceptual introduction by Thomson, has gained in quick succession universal acceptance for refrigeration and space cooling.

One hundred and sixty-seven years after Thomson's conception, however, heat pumps' application for space heating is still limited in scope. The most common heat pumps, air source heat pumps (ASHPs), face operational challenges: their efficiency and capacity drop during extreme weathers just when demand is the greatest. This is the result of decreasing coefficient of performance (COP) under large temperature lip as well as requirement of de-frosting and the mismatching between machine capacity and building load. These challenges are sufficiently serious that another-type heat pumps based on a different heat-source, ground source heat pumps (GSHPs), have become widely popular. GSHPs use the earth as a heat source or a heat sink taking advantage of the moderate temperatures in the ground-earth to boost efficiency and reduce the operational costs of heating and cooling.

Because of GSHPs' high COP, they have been successfully adopted in Sweden and Switzerland. This success is a remarkable reflection of the advantage of GSHPs, in particular, an evidence that wide adoption of GSHPs does not exacerbate peak load problem for a national power grid system.

Their popularity in general and small examples of success in particular, however, do not translate into their universal market adoption supplanting the common ASHPs. In a 2009 study-report prepared for EERE of US DOE, [¹] Navigant concluded that GSHPs' market penetration in US is limited as result of three barriers:
Cost difficulty of evaluating the suitability of individual installation sites
Installation-specific design and engineering of the ground loop generally required
Space requirements for ground coupling can be problematic in densely built areas. ¹ Navigant Consulting, Inc. (Feb. 3, 2009). “Ground Source Heat Pumps:

### Overview of Market Status, Barriers to Adoption, and Options for Overcoming Barriers,”

### Submitted to: U.S. Department of Energy Energy Efficiency and Renewable Energy Geothermal Technologies Program

All three are the direct consequence of earth being poor heat transfer medium and, as a result, GSHPs adoption is costly in capital and demands economic conditions and well-established service-infrastructure that do not prevail in US—while individual adoptions are possible as in Sweden and Switzerland, such adoptions cannot be scaled up in US or worldwide.

TABLE 1
Pros and Cons of four types of heat pumps in their application
to heating: ASHPs, GSHPs, parallel SAHPs, series SAHPs

| | ASHPs | GSHPs | parallel SAHPs | series SAHPs |
|---|---|---|---|---|
| Pros | | | | |
| Cost | Low cost | | | |
| operation | | Reliable and durable | | Reliable and durable |
| | | operation | | operation |
| eff. | | High COP | High system COP | High machine COP |
| peak | | do not exacerbate | | |
| load | | peak-load because of | | |
| | | high COP | | |
| Source | Air source is widely | | Dual heat sources | |
| | available | | | |
| Scale | Ready to scale up | | | |
| Cons | | | | |
| Cost | | High cost | | |
| operation | Heat pump units | | Heat pump units | |
| | operate under large | | operate under large | |
| | temperature lift | | temperature lift | |
| eff. | Low COP | | Low machine COP | Heat pump |
| | | | | starvation, thus, low |
| | | | | system COP |
| Source | | Earth being a poor | | Still a single source |
| | | heat transfer medium | | |
| Scale | | Difficult to scale up | | |

Yet another-type heat pumps, solar assisted heat pumps (SAHPs) or combined solar and heat pump systems, have received considerable attention. In a position paper by Solar Heating & Cooling Programme, IEA,[²] it noted, “Solar and heat pump systems (S+HP) are a combined technology that represent a market share in the building heating and cooling segment due to their following advantages . . . . The market share of S+HP systems could reach 100% for new houses in many countries where the heat pump technology is well-established and solar is mandatory for domestic hot water . . . .”² SHC, IEA_“Solar and Heat Pump Systems Position Paper,” TASK 44/Annex 38 Solar and Heat Pump Systems

Perhaps, the case for SAHPs was put best by Chu and Cruickshank (2014),[³] “the use of solar thermal and heat pump technology together has the potential of alleviating the limitations each system experiences individually in cold weather.” Stand-alone solar cannot ensure meeting the heating load requirement during coldest days and nights, nor does stand-alone ASHP deliver necessary capacity just when heating demand is the greatest. The logic of the system approach by combining the two units is, therefore, in searching for synergy in the combined systems transcending the limits of stand-alone units. In particular, one of the challenges stand-alone units face is peak-load problem: both stand-alone units necessitate significant auxiliary heating that exacerbates peak-load demand. ³ Chu and Cruickshank (November, 2014) “Solar assisted heat pump systems,” Journal of Solar Energy Engineering 136 (041013): 1-9

The schematics of parallel version and series version are shown in FIG. 1 and FIG. 2:

We have carried out performance study of both SAHPs as depicted in FIG. 1 and FIG. 2 in a 2019 master thesis. [⁴] Summary of the study on parallel SAHPs and series SAHPs are shown in Table 1. The highlights on both versions of SAHPs as well as ASHPs and GSHPs as shown in Table 1 are the following: ⁴ Zhenyu Xia (May 2019). “Combined solar and heat-pump (S+HP) systems: Comparing the parallel S+HP system and the series S+HP system,” Master Thesis, Stony Brook University
1. A stand-alone ASHP has the drawback of low operational COP in cold weather as a result of its operation under large temperature lift; additional comment on mitigating this problem will be made below in this section.
2. GSHPs offer solution to the core drawback of ASHPs by using earth heat source; but, at the same time as a result of using earth heat source, the design and engineering of GSHPs cannot be standardized for scaling-up of the technology. This is indeed disheartening because GSHPs is the only one in Table 1 that does not exacerbate peak-load problem.
3. Of the two SAHPs, the parallel SAHP enjoys the significant advantage of dual sources with both air and solar resulting in excellent system COP equaling that of GSHPs, but its heat pump unit's machine COP is low due to large temperature lift. Exacerbation of peak-load remains a problem.
4. Of the two SAHPs, the machine COP of the series SAHP is high equaling that of GSHPs. But, this advantage is cancelled out as well as a promise unfulfilled. Cancelled out as a result of heat pump starvation due to being a single solar heat source resulting in low system COP. Promise unfulfilled because, even though with high machine COP, exacerbation of peak-load remains a problem because of heat pump starvation.
5. The expectation in alleviating limitations of individual solar and heat pump with combining the two in either parallel version or series version is only partially validated: both versions show significant improvement in operational COP. However, since one of the challenges stand-alone units face is peak-load problem and neither version succeeds in its resolution, the verdict on the combined solar and heat pump systems is that they are unsuccessive in transcending the limitations of individual solar unit and heat pump unit.

This analysis can be recapitulated to be that an ideal heat pump system that can capture synergy of solar and heat pump should meet both the criterion of (1) high machine COP so that its wide adoption will not exacerbate peak-load of a power grid and the criterion of (2) high system COP by availing itself of dual heat sources. Moreover, it should always meet the criterion of (3) an engineering solution that is scale-up-able. ASHPs fail both criteria (1) and (2); GSHPs meet both criteria but fail criterion (3); parallel SAHPs fail criterion (1); series SAHPs meet criterion (1) but not criterion (2) because of heat pump starvation resulting from failing to avail themselves of dual heat sources (despite its high machine COP, exacerbating peak-load remains a problem).

An additional comment is added here with regards to a known method for partially mitigating large temperature lift problem, which leads to inferior COP. The method, multistage compression refrigeration system or, two-stage vapor-compression refrigeration with a flash chamber, [⁵] breaks both compression step and throttling step into two respective steps as shown in FIG. 3. By breaking into two stages, such refrigeration or heat pump operation results in improvement in COP. ⁵ Cengel and Boles (2008) Thermodynamics: An Engineering Approach. Sixth Edition (McGrawHill)

It turns out that if a series SAHP is transformed into a dual-heat-sources system for overcoming heat pump starvation it can potentially meet all three criteria. It is the objective of the invention to provide a method of using heat pump for heating with the dual heat sources of air and solar with synergetic coordination in the extractions of heat from both sources. It is also the objective of the invention to provide an apparatus serving as the centerpiece for managing and coordinating heat extractions from both sources. It is furthermore the objective of the invention that the application of the method and the apparatus does not exacerbate peak-load problems of grids. Yet another objective of the invention, which was unexpected, is to provide a method of using said apparatus for managing cooling with single air heat reservoir without exacerbating peak-load problems of grids during summer.

### BRIEF SUMMARY OF THE INVENTION

The use of heat pump for heating has not been widely adopted. Prevalent heating and cooling equipment are an odd mix of air-conditioner, i.e., heat pump which is electric powered, for cooling and combustion boiler, which is fired by fuels, for heating. It is our aim to develop a single, electric-powered heat pump system for the multi-function of water heating, space heating/cooling that performs heating function better than all existing heat pump apparatuses. In particular, we have reached the verdict on the existing combined solar and heat pump systems that they are unsuccessive in transcending the limitations of individual solar unit and heat pump unit. One objective of the invention is to provide a method of using heat pump for heating with dual heat sources of air and solar with synergetic coordination in the extractions of heat from both sources. Another objective of the invention is to provide an apparatus serving as the centerpiece for managing and coordinating said heat extractions from both sources. Specifically, in the managing and coordination, the heat pump unit of the apparatus, which comprises a TES unit and an eHeatPump unit, operates in two modes, a TES discharging mode (either discharging heat by heat extracting or discharging coolness by heat dissipation) and a TES charging mode, in such a manner that the timing of the pre-charging operation is flexible for avoiding peak load as controlled by model predictive control (MPC) as well as for scheduling pre-charging during lowest power cost period. The two objectives together aim for transcending the limitations of individual solar unit and heat pump unit. A further objective of the invention is to provide a method of using the apparatus for managing cooling with single air heat reservoir.

An apparatus for building heating and cooling, comprising a thermal energy storage of water tank; an eHeatPump heat extraction means having two operational modes, discharging Mode 1 and charging Mode 2; said eHeatPump being in communication, in Mode 1, with said water tank extracting heat from which and a building space delivering heat to which, while, in Mode 2, in communication with an outdoor fan/heat exchanger unit extracting heat from which and said water tank delivering heat to which; in this Mode 2 operation the temperature of water in said water tank is precharged for anticipated requirement of building space conditioning; whereby the objective of such interactions and communications among the water tank, the eHeatPump, the outdoor fan/heat exchanger unit, and the building space being to breaking a single heat extraction process over large temperature lift during cold periods into two steps of smaller temperature lifts, the first being the Mode 2 operation precharging the water tank and the second being the later Mode 1 operation meeting building space heating load. The apparatus is also known as two-phase compression heat pump system with a thermal energy storage (TES) unit (FIG. 5).

A method of managing low-grade-heat for water heating and space heating and cooling, comprising (a) providing exact heat extraction means via the use of a device for heat pumping, known as eHeatPump, in combination with a device for thermal energy storage (TES); (b) means for extracting low-grade heat of solar irradiation for maintaining the thermal condition of said device for thermal energy storage; (c) means for extracting low-grade heat of air enthalpy for pre-charging the thermal condition of said device for thermal energy storage, thereby mitigating heat pump starvation resulting from the prolong operation of heat pumping or absence of solar irradiation. Whereby, a low-grade-heat managing heat pump (LMHP) system operating as a managing means by storing heat/cold and extracting heat rather than as an energy conversion means, and the managing means has access to dual heat sources with eHeatPump operating in two operational modes; the timing of operating the charging Mode 2, when it is operated as a precharging mode, has the flexibility as controlled by MPC to avoid power peak load period, i.e., to take place during off-peak period taking advantage of low cost power; thereby, the dual-sourced LMHP system transcends the limitation of stand-alone ASHP and stand-alone solar system.

Another method of applying the apparatus of two-phase compression heat pump system with a TES for building cooling and refrigeration, comprising (a) providing exact heat extraction means via the use of a device for heat pumping, known as eHeatPump, in combination with a TES device for thermal energy storage; (b) means for cooling-conditioning of space by discharging heat into TES; (c) means for pre-conditioning (precooling) the thermal condition of said TES; whereby with eHeatPump operating in two modes, conditioning Mode 1 and precharging or preconditioning Mode 2, and the timing of operating the precharging Mode 2 has the flexibility as controlled by MPC to avoid power peak load period as well as take advantage of low-power-cost period.

### BRIEF DESCRIPTION OF THE DRAWINGS

FIG. 1_A parallel solar assisted heat pump (SAHP)

FIG. 2_A series SAHP with electric resistive element

FIG. 3_A two-stage compression refrigeration system with a flash chamber

FIG. 4_Schematic of heat pump management of dual heat sources for building heating

FIG. 5_A two-phase compression heat-pump system with a thermal energy storage (TES) unit

FIG. 6_Another embodiment of the two-phase compression heat-pump system with a thermal energy storage (TES) unit

FIG. 7_Embodiment as shown in FIG. 6 in discharging phase operation

FIG. 8_Embodiment as shown in FIG. 6 in charging phase operation

FIG. 9_LMHP for heating and cooling depicted in heating operation with dual heat sources

FIG. 10_LMHP for water-heating and space heating&cooling depicted in heating operation with added Grid Integrated Water Heater with resistive element and GIWH control unit, as well as space-heating-and-cooling grid-integration control unit, which controls the operation of compressor and four control valves

FIG. 11_LMHP for heating and cooling depicted in cooling operation with reversing valve in cooling position and solar collectors de-activated

FIG. 12_A two-phase compression air-conditioner/refrigerator with a TES unit; the method can also be used for heating with a single air heat source—in which case, the heat pump reversing valve is set in heating position and the outdoor heat exchanger 10 works as heat extractor in charging phase operation

FIG. 13_Cooling system electric demand profile during three days in summer, which demonstrates the cost and moderate-peak-load advantage of the two-phase compression air-conditioner with a TES unit

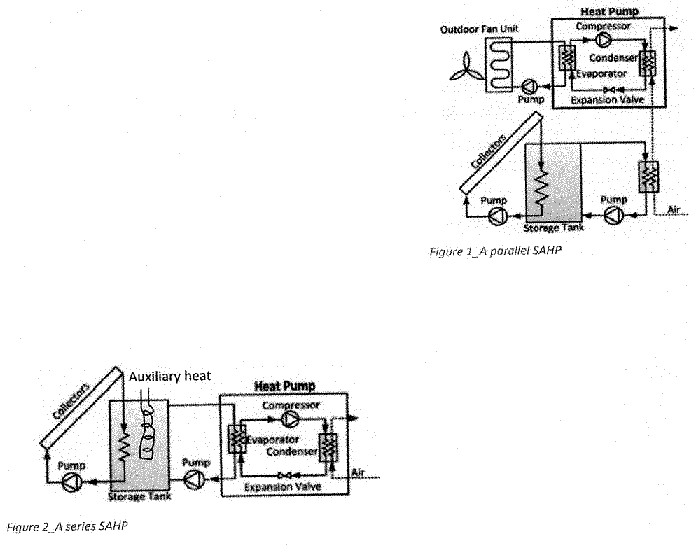

### DETAILED DESCRIPTION OF THE INVENTION

It is our aim to devise a single, electric-powered heat pump device for heating and cooling. For that aim the invention has the following objectives. One objective of the invention is to provide a method of using heat pump for heating with dual heat sources of air and solar with synergetic coordination in the extractions of both sources. Another objective of the invention is to provide an apparatus serving as the centerpiece for managing and coordinating said extractions of both sources. Specifically, in the managing and coordination, the heat pump unit of the apparatus, which comprises a TES unit and an eHeatPump unit, operates in two modes, a heating mode and a pre-charging mode, in such a manner that the timing of the pre-charging mode operation is flexible for avoiding peak load as controlled by model predictive control (MPC). A further objective of the invention is to provide a method of using the apparatus for managing cooling with single air heat reservoir.

### Definitions

The method for heating and cooling of this invention is called low-grade-heat managing heat pump (LMHP). Low-grade-heat here refers to heat in an air heat reservoir, or both heat in an air heat reservoir and heat collected by solar thermal panels. Air heat reservoir can serve as a heat source or a heat sink.

In this invention, TES means a thermal energy storage unit, one embodiment of which is a water tank. In this invention, heat pump means an electric powered, vapor-compression-cycle device.

In the context of heat pump cycle, a Carnot heat pump is identified as a perfect heat extraction device. Correspondingly, a vapor-compression-cycle heat pump if it is operating under moderate temperature lift is identified as an “exact heat extraction” device (as an approximation to the perfect heat extraction device) whereas a vapor-compression-cycle heat pump operating under large temperature lift is said to be not meeting the criterion of “exact heat extraction” approximation. Therefore, the heat extraction means that this invention introduces for keeping the “temperature lifting of heat extraction operation” from becoming excessively large by breaking the step into two steps is called exact-heat-extraction HeatPump (short for eHeatPump); the breakup into two steps is assisted with TES.

In both apparatus and method, the eHeatPump operates in two modes or two phases, which will be referred to as either first mode/second mode or first phase/second phase, or mode one/mode two or phase one/phase two. The first mode/phase will be referred to as TES discharging mode/phase, while the second mode/phase as TES charging mode/phase. In the first mode/phase, TES will be considered as the “source” for the eHeatPump operation, i.e., in the case of heating application, TES is the source of heat (a heat source) for eHeatPump, while, in the case of cooling application, it is the source of coolness for eHeatPump in the sense that it serves as a heat sink for eHeatPump enabling the eHeatPump to remove heat from chilled space.

This invention considers the option of hydronically distributed heat, which then activates radiant surfaces for space heating or/and cooling. The method is called thermally activated building systems (TABS).

### The True Meaning of Efficient Methods

It is a universally accepted truism that all changes in nature (including methods or processes of efficient operations or devices) can be understood in terms of energy conversion, with those of efficient energy conversion being energy conversion that involves small energy degradation. Note that energy conversion is fundamentally a description of dyadic relation of cause and effect between high-grade energy and low-grade energy, eventually becoming heat. As dyadic relations in the narrow sense of the term, energy conversion, strictly speaking, cannot capture the true meaning of efficient methods.

The energy conversion truism, together and the mechanical theory of heat from which the truism was derived, has been rejected by Lin-Shu Wang. [⁶] The mechanical theory of heat is supplanted by the predicative entropy theory of heat. In place of energy conversion, truly efficient processes are described in terms of triadic relations (or, the triadic framework) and the ecosystem of triadic relations. For building energy problems, efficient methods are understood in the triads of e-powered managing means, extraction of low-grade-heat, and building space conditioning. That is, the truly efficient methods for building conditioning involve the use of e-powered apparatus such as heat pump/thermal storage system for storing heat/cold and extracting heat, i.e., as low-grade heat managing means, for achieving the desired space conditioning, rather than as energy conversion means. Furthermore, overall efficiency is greatly amplified with individual building triadic relations as components in the triadic ecosystem of individual buildings, power grid, and renewable solar/wind farms. ⁶ L-S. Wang (July, 2019) A Treatise of Heat and Energy (Springer_Mechanical Engineering Series)

### DETAILED DESCRIPTION

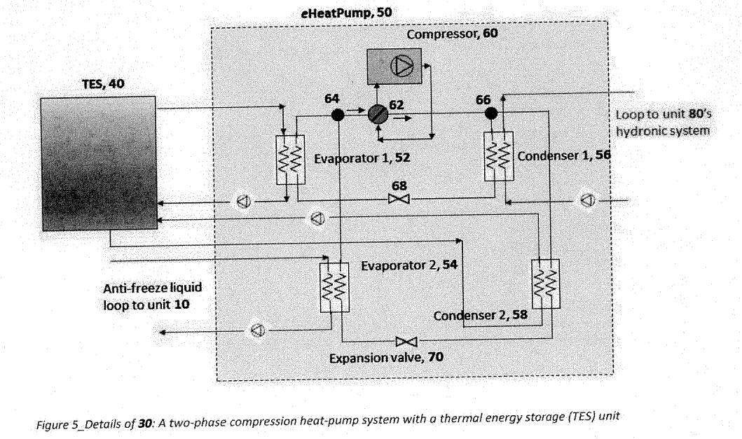

FIG. 4 depicts LMHP method for heating with dual heat sources of air heat 10 and solar heat 20. The organizing principle of one embodiment of invention as depicted in FIG. 4 is the triad of TES+eHeatPump and auxiliary pumps 30, low-grade-heat of air heat 10 and solar heat 20, and a building/thermal-system 80 being maintained in thermal homeostasis. Air heat is extracted by unit 10 shown as outdoor fan/heat-exchanger unit. Solar heat is extracted or collected by unit 20 shown as solar collectors. The device of TES+eHeatPump is shown as 30.

The schematic of one embodiment of the apparatus 30 is shown in FIG. 5. For the heating-conditioning application, as long as solar irradiation is available the solar collectors 20 extract solar heat for maintaining thermal condition in TES 40. With eHeatPump 50 operating in Mode 1, the compressor 60 of eHeatPump 50 drives refrigerant with valve 64 in position connecting the inlet of 60 and refrigerant line to evaporator 1, unit 52; reversing valve 62 is shown in position for this connection. Correspondingly, the positions of 62 and valve 66 are such that connection exists between the outlet of 60 and refrigerant line to condenser 1, unit 56. Driven by 60, high temperature and high-pressure refrigerant is fed through 56 delivering heat to “loop to unit 80's hydronic system,” which is one embodiment of heat distribution in thermal system 80. Thereafter, cooled high pressure refrigerant undergoes expansion-cooling process through expansion valve 68 resulting in cool refrigerant mixture, which then passes through 52 extracting heat from liquid circulating through 40. The end result of these steps, which are in totality referred to as heating-conditioning application of mode one, is the extraction of heat from 40 (i.e., 40 discharging mode) and the delivery of this heat plus the energy input to 60 to be hydronically distributed to TABS in unit 80.

Mode two of eHeatPump is the TES (40) charging mode: valves 64 and 66 are switched to connect the inlet of 60 to refrigerant line to evaporator 2, unit 54, and the outlet of 60 to refrigerant line to condenser 2, unit 58. The operation of 50 in Mode 2 thus extracts heat, through the circulation of anti-freeze liquid, from air heat via unit 10, and, as shown in FIG. 5, energy input to 60 adds to the extracted heat to be delivered by condenser 2, unit 58, to circulating liquid delivered to TES 40. Charging mode may operate as recharging of TES 40, as needed, when it becomes depleted or as precharging of TES 40. Precharging mode operates either continuously or intermittently until MPC determines that the TES is ready for meeting the coming heating requirement. The timing of precharging operation has flexibility in the present apparatus 30 resulting from the availability of TES 40 and the interaction between TES 40 and eHeatPump 50.

For the cooling-conditioning application, reversing valve 62 is set in the other position from that shown in FIG. 5. In its new position of 62, the compressor 60 of eHeatPump 50 drives refrigerant connecting the inlet of 60 and refrigerant line to heat exchanger unit 56, which now functions as evaporator, and refrigerant connecting the outlet of 60 and refrigerant line to heat exchanger unit 52, which now functions as condenser. In mode one operation the apparatus extracts heat from the thermal system 80 and dissipates the sum of the extracted heat and compressor energy input that turns into heat into TES 40 as heat sink. Correspondingly, TES should be precharged into sufficiently chill condition by the mode two operation of the apparatus so that it is ready to function as an effective heat sink.

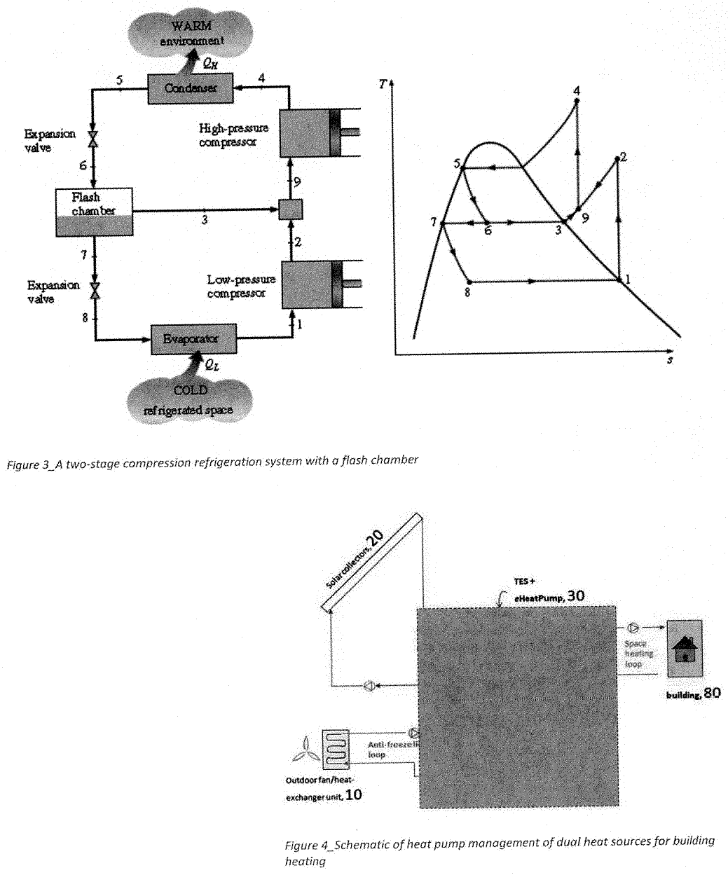

An important difference of the apparatus 30 shown in FIG. 5 from the prior art of multistage compression refrigeration system shown in FIG. 3 is that the latter breaks compression step into two stages both of which operate simultaneously whereas the former breaks compression step into two phases, the precharging or precooling phase and the discharging phase, with the precooling phase operating at an earlier time. For this reason, we may call apparatus 30 two-phase compression heat pump with a thermal energy storage unit (TES), with the operative word “phase” signaling that compression is carried out in two stages out of phase and, additionally, the inclusion of TES as an element enabling the out-of-phase operation.

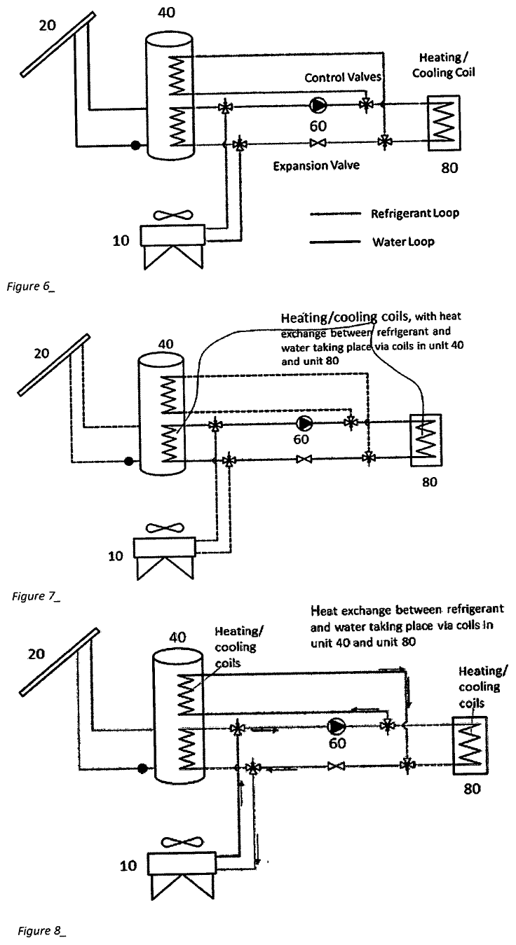

An alternative embodiment of the apparatus 30 is shown in FIG. 6. In this embodiment, the heat exchanger 52 is integrated into TES 40, and the heat exchanger 56 in integrated into thermal system 80. As a result, for discharging operation (mode one operation) the refrigerant is directly evaporated and condensed in TES and thermal-system, respectively, as shown in FIG. 7. In the case of cooling application, evaporated/condensed is reversed to be condensed/evaporated. For charging operation (mode two operation) the refrigerant is directly condensed/evaporated in TES/outdoor-heat-exchanger, respectively, as shown in FIG. 8. In the case of cooling application, condensed/evaporated is reversed.

A schematic of the heating operation of LMHP method is shown in FIG. 9. LMHP operates normally in Mode 1 of eHeatPump. Background reference may be made to the series SAHP as shown in FIG. 2. With the deletion of Mode 2 operation in eHeatPump 50 and correspondingly the removal of outdoor heat exchanger 10, the system in FIG. 9 reduces to series SAHP as shown in FIG. 2. When its storage tank becomes insufficiently charged, the series SAHP operates under heat pump starvation, which necessitates activation of auxiliary resistance heating as suggested in FIG. 2. Instead, with the availability of Mode 2 in its operation, correspondingly, the availability of the second heat source (10), LMHP operates, when its TES 40 becomes insufficiently charged, with the following steps: eHeatPump switches to Mode 2: valves 64 and 66 are switched to connect the inlet of 60 to refrigerant line to evaporator 2, unit 54, and the outlet of 60 to refrigerant line to condenser 2, unit 58. The operation of 50 in Mode 2 thus extracts heat, through the circulation of anti-freeze liquid, from air heat via unit 10, and, as shown in FIG. 5 and FIG. 9, energy input to 60 adds to the extracted heat to be delivered by condenser 2, unit 58, to circulating liquid delivered to TES 40. That describes Mode 2 operation of 50 as a recharging (regenerative charging) of 40 for preventing heat pump starvation.

A compromise for preventing heat pump starvation is proposed here that is structurally identical with SAHP, but with a difference in its operational control, as shown in FIG. 2. As the example of Grid Integrated Water Heater (GIWH), as described in [Lazar, J. (2016). Teaching the “Duck” to Fly, Second Edition. Montpelier, Vt.: The Regulatory Assistance Project], has shown that the use of electric resistive heating can be environmentally and economically beneficial if the electricity is derived from excess grid electricity output from renewable sources, the proposed embodiment of LMHP replaces, for precharging TES 40, the mode-two operation of 50 with resistive heating. Both the original mode-two operation and its replacement are powered by excess grid electricity. The key is that charging in the present case is necessarily precharging rather than recharging, which will not have the flexibility in timing of having availability of excess grid electricity. Use of model predicative control (MPC) controller to determine the required thermal condition of 40 is necessary. The resulting LMHP is structurally the same as SAHP just as GIWH being structurally the same as electric resistance WH. Its environmental and economic benefits result from grid integration. We may refer to this embodiment of LMHP as grid-integrated SAHP.

Another charging option of using Mode 2 operation, instead of recharging, is precharging of 40. Sensors monitoring 80 and 40, and weather prediction are inputted to a model predicative control (MPC) controller to determine the required thermal condition of 40 for predicting charging need of TES 40 in addition to what is being inputted from 20. If a decision for such charging need is made, eHeatPump switches to Mode 2, the pre-charging mode, which follows exactly the same steps as the recharging steps: valves 64 and 66 are switched to connect the inlet of 60 to refrigerant line to evaporator 2, unit 54, and the outlet of 60 to refrigerant line to condenser 2, unit 58. The operation of 50 in Mode 2 thus extracts heat, through the circulation of anti-freeze liquid, from air heat via unit 10, and, as shown in FIG. 6, energy input to 60 adds to the extracted heat to be delivered by condenser 2, unit 58, to circulating liquid delivered to TES 40. Precharging mode operates either continuously or intermittently until MPC determines that the TES is ready for meeting the coming heating requirement. With that Mode 2 operation, LMHP breakdowns heat extraction step over large temperature difference into two temperature differences of moderate temperature lifts. The timing of precharging operation has flexibility in the present method resulting from the availability of TES 40 and the interaction between TES 40 and eHeatPump 50. This timing flexibility solves peak-load problem as well as avails LMHP method of low-cost electricity.

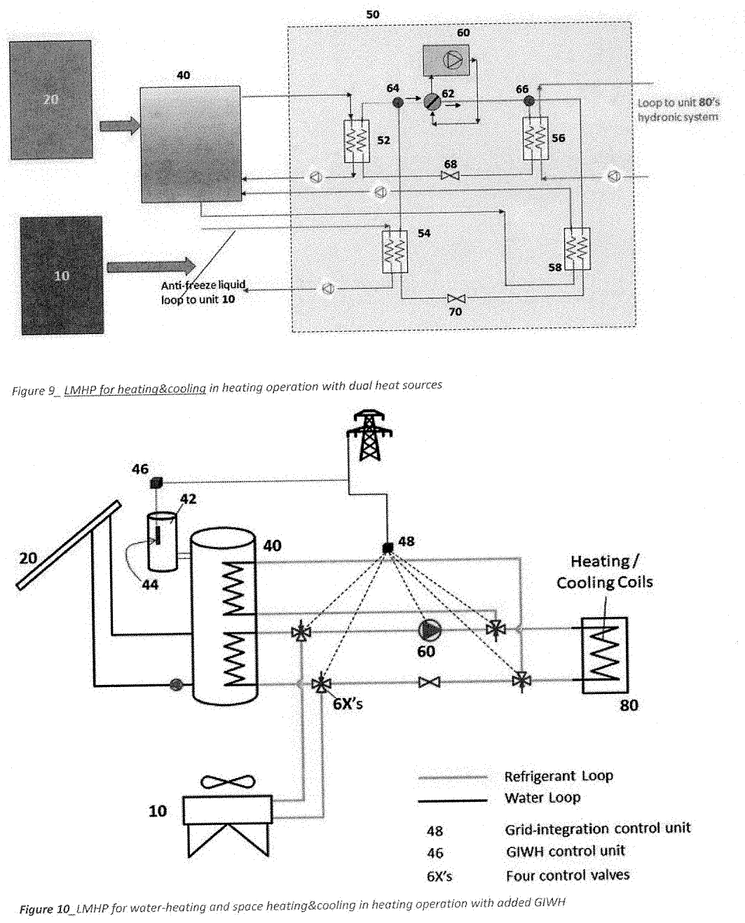

The heating application of LMHP method is further refined by adding water heating to the space heating/cooling by adding a smaller water heater 42 to the existing TES 40, as shown in FIG. 10. The water heater is equipped with electric resistive element 44, the operation of which is controlled by Grid Integrated Water Heater (GIWH) control unit, 46, as described in Lazar, J. (2016). Teaching the “Duck” to Fly, Second Edition. Montpelier, Vt.: The Regulatory Assistance Project.

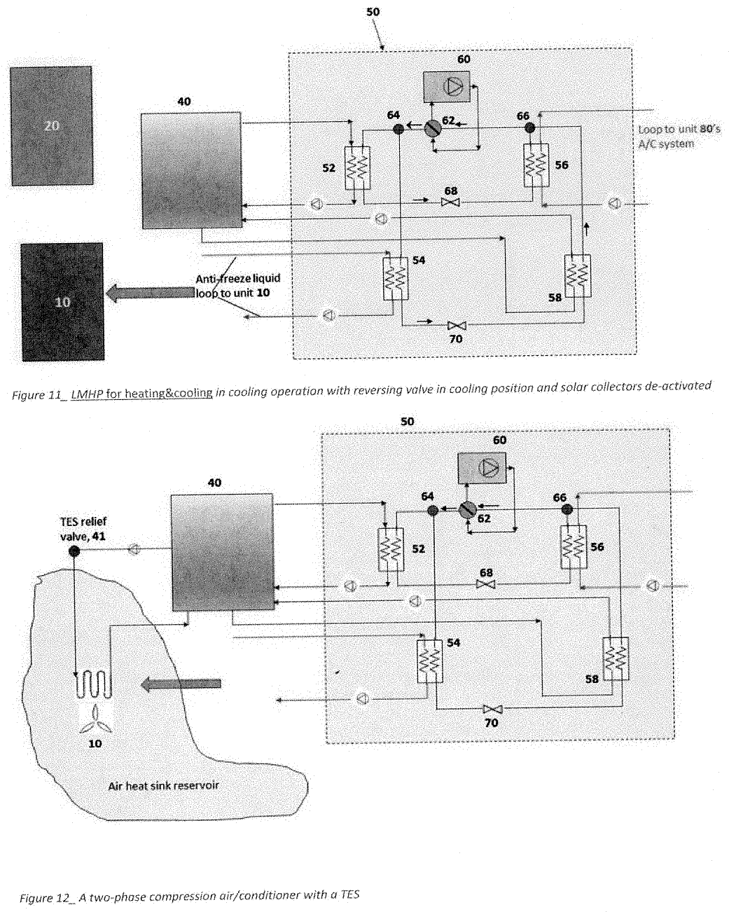

A schematic of the cooling operation of LMHP method is shown in FIG. 11. As shown, solar collectors 20 is deactivated and reversing valve 62 is set for cooling operation position. In Mode 1, the position of 66 are such that the inlet of 60 is connected to refrigerant line to unit 56, which functions as evaporator extracting heat from “loop to unit 80's A/C system.” Correspondingly, the positions of valve 64 are such that connection exists between the outlet of 60 and refrigerant line to unit 52, which functions as condenser dispensing heat to TES 40. The end result of these arrangements is the extraction of heat from 80 and the delivery of this heat plus the energy input to 60 to be dissipated in TES 40. As the required energy input to 60 is dependent on temperature lift as imposed by the temperature of 80 and the temperature of 40, it is desirable to keep the temperature at moderate level even when ambient air temperature is high. Mode 2 operation of 50 can be used for precharging, i.e., precooling, of TES 40: The positions of 64 and 66 are set such that the inlet of 60 is connected to refrigerant line to unit 58 as evaporator, and the outlet of 60 is connected to refrigerant line to unit 54 as condenser. The end result of these arrangements is the extracting heat from 40, i.e., precooling of 40 and the dispensing of heat through 10 to be dissipated to air heat sink reservoir. The timing of precharging operation has flexibility in the present method resulting from the availability of TES 40 and the interaction between TES 40 and eHeatPump 50. This timing flexibility solves peak-load problem as well as avails LMHP method of low-cost electricity.

The same kind of grid integration in the application and control of GIWH is designed/developed in the application and control of LMHPs. In the application of LMHP method, as shown in FIG. 10, thermal energy storage/water heater are equipped with sensor-instrument and building thermal system are equipped with sensor-instruments as well. Data from which are entered into a modeling predictive control (MPC) controller that determines, with sensor data combined with inputs of weather forecast, the extent of precharging the thermal energy storage for meeting anticipated building conditioning need. Additionally, the controller unit 48 is coordinated with building user behavior data and grid data including minute-to-minute utility rate schedule for both refining precharging/discharging operation and demand-response charging, respectively, by controlling valves 6×'s (6×1, 6×2, 6×3, and 6×4) with unit 48 and, with electric resistance element in said water heater, providing ancillary services to utility for voltage support and frequency regulation as controlled by grid-integrated water heating control unit 46. Whereby, LMHP operates as a multi-function, grid-interactive low-grade-heat managing method, and the apparatus may be referred to as multi-function, grid-interactive heat pump.

This leads to the application of two-phase compression heat pump with a TES unit to air-conditioning application, as well as the application of LMHP method for cooling and heating with single air heat sink and air heat source, respectively. This is an unexpected use of the apparatus, which was originally conceived as dual source heating of solar and air, stressing the synergy of dual sources transcending the limitations of individual sources. As the case depicted in FIG. 11, LMHP, for the application of LMHP to cooling, naturally involves a single heat reservoir of air. The point is that important advantage derived from the use of thermal energy storage by LMHP apparatus and method remain for the case of single-source heat reservoir.

FIG. 12 depicts air-conditioning and refrigeration method-application of the apparatus. Details are the same as FIG. 11: In Mode 1, the position of 66 are such that the inlet of 60 is connected to refrigerant line to unit 56, which functions as evaporator extracting heat from “loop to unit's A/C system.” Correspondingly, the positions of valve 64 are such that connection exists between the outlet of 60 and refrigerant line to unit 52, which functions as condenser dispensing heat to TES 40. The end result of these arrangements is the extraction of heat from 80 and the delivery of this heat plus the energy input to 60 to be dissipated in TES 40. As the required energy input to 60 is dependent on temperature lift as imposed by the temperature of 80 and the temperature of 40, it is desirable to keep the water temperature of 40 at moderate level even when ambient air temperature is high. Mode 2 operation of 50 can be used for that purpose precharging, i.e., precooling, of TES 40. The positions of 64 and 66 are set such that the inlet of 60 is connected to refrigerant line to unit 58 as evaporator, and the outlet of 60 is connected to refrigerant line to unit 54 as condenser. The end result of these arrangements is the extracting heat from 40, i.e., precooling of 40 and the dispensing of heat through 10 to be dissipated to air heat sink reservoir. When MPC controlled precooling of 40 is inadequate resulting in the water temperature to be higher than ambient air temperature during the operation of 50 in Mode 1, a TES relief valve 41 is open so that water in 40 is circulated to 10 and directly cooled via 10 by ambient air. We call 41 TES relief valve to indicate that, with the proper function of MPC, it is anticipated that the operation of 41 opening will be limited to short durations during a cooling season.

One example of utility rate schedule is that of Con Edition of NYC: Its summer peak hours are between June 1 and September 30, and daily from 8 AM to midnight with peak rate of 21.8 cents/kWh. Its off-peak rate is 1.54 cents/kWh, a difference of 14 times. With the effective use of MPC, in this instance, LMHP can operate in Mode 2 each night for the precooling of 40, which is extremely cost effective, whereas with 40 being adequately precooled so that LMHP operates in Mode 1 as needed in the daytime with moderate temperature lift so that the daytime peak-load rated energy expenditure can be minimized. The criterion of what constitutes best precooling scheduling will obviously not be a pure matter of “total” quantity of energy consumed but a matter of the “timing” of each part of energy being consumed. The scheduling or timing has to be “custom-tailored” dependent on each case of rate schedule.

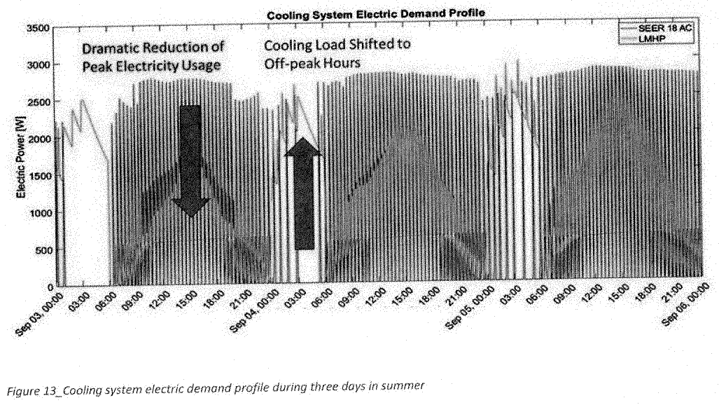

A simulation of air-conditioning operation shows, in FIG. 13, the dramatic reduction in electric demand by cooling system during peak hours from about 2.7 kW with a conventional SEER 18 central AC to about 0.6 kW with LMHP. This peak demand reduction is offset by consumption of off-peak electricity supply, which (both peak demand reduction and useful application of off-peak supply) result in overall load balancing.

For heating application in this case, not shown, the reversing valve 62 is switched to heating position. Air heat is the single heat source. What distinguishes LMHP from ASHP is the preheating of TES 40 with eHeatPump 50 operating in Mode 2 so that eHeatPump 50 operating in Mode 1 can deliver heat to 80 with moderate temperature lift because of the thermal condition of 40, an important advantage especially during extreme low ambient air temperature. With the effective use of MPC, peak load can be mitigated and the preheating of 40 can be done during attractive power rate period.

In sum, the apparatus of two-phase compression heat pump with a TES provides two modes of heat extraction operation that, by breaking up the weather-imposed large heat-extraction-step into separate charging phase and depleting or conditioning phase, brings about superior operational efficiency as measured by both machine COP and system COP, and flexibility in the timing of pre-charging phase that results in significant operational cost benefit. In its heating application using dual heat sources of solar and air via heat pump heat extraction, LM heat pump system (LMHP system) transcends the limitations of individual solar system and individual AS heat pump system.

The above description and examples should be not construed as limitations on the scope of the invention. Many other variations are possible. Accordingly, the scope of the invention is determined by the claims and their legal equivalents.

What is claimed is:

1. An apparatus for heating and cooling, comprising
a. a heat extraction means having two operational modes, first mode and second mode;
b. a thermal energy storage (TES), filled with an energy storage medium of a predetermined heat capacity;
c. said heat extraction means being in heat transfer communication in the first mode with said thermal energy storage, as its source, and a thermal system to be conditioned, while it, in the second mode, being in heat transfer communication with said thermal energy storage and ambient air;
d. switching from the first mode to the second mode, the heat transfer communication of said heat extraction means with respect to said thermal energy storage reverses direction from discharging TES/source, for said thermal system conditioning, to charging TES, respectively;
whereby the second mode of TES charging prepares the TES so that when it serves as source for said heat extraction means in its first mode it exists at favorable conditions, i.e., adequately charged, enabling discharging mode operating at high performance.

2. The apparatus of claim 1 wherein energy storage medium of said TES is water.

3. The apparatus of claim 1 wherein said heat extraction means is an electric-powered, vapor-compression heat pump, the two mode operations of which are controlled by valves (64 and 66) that connect compressor input and outlet to two alternate sets of heat exchangers.

4. The apparatus of claim 1 wherein said heat extraction means is an electric-powered, vapor-compression heat pump, the two mode operations of which are controlled by valves that route refrigerant to two sets of heating/cooling coils in TES, with one set connected to heating/cooling coil in thermal system and the other to heating/cooling coil in outdoor heat exchanger unit.

5. The apparatus of claim 1, wherein said thermal energy storage is charged by solar irradiation directly in the case of heating application as well as other available low-grade heat sources/sinks directly in general applications.

6. The apparatus of claim 1, wherein said TES is equipped with electric resistive element.

7. The apparatus of claim 1, wherein said thermal energy storage being equipped with grid integration control unit for both demand-response charging and, with electric resistance element in said thermal energy storage, ancillary services to utility for voltage support and frequency regulation.

8. A method of managing low-grade-heat for water heating and building heating and cooling, comprising
a. providing exact heat extraction via the use of a device for heat pumping in two phases, first phase and second phase, enabled with a device for thermal energy storage (TES);
b. means for charging, or maintaining the thermal condition of, said thermal energy storage device in the second phase;
c. means for discharging said thermal energy storage device with the operation of said heat pumping device in the first phase for delivering heat to or removing heat from a building space;
whereby a low-grade-heat managing heat pump (LMHP) system operating as low-grade heat managing means, rather than as energy conversion means, with alternate charging and discharging phases resulting in flexibility in the operating timing of the charging phase, thus, building load flexibility and decoupling in building heating and cooling performance, substantially, from extreme weather impact.

9. The method of claim 8, wherein said low-grade-heat includes heat of an ambient air heat reservoir, which serves as a heat source as well as a heat sink.

10. The method of claim 8, wherein said low-grade-heat in the heating application includes heat of the ambient air heat source and heat of solar irradiation; said thermal energy storage charging means further includes heat collection with solar thermal panels;
whereby LMHPs in the heating application have access to dual heat sources.

11. The method of claim 8, wherein said charging of thermal energy storage comprising recharging, i.e., regenerative charging, of thermal energy storage after it being depleted and precharging of thermal energy storage for preparing it at required thermal conditions before an anticipated period of withdrawal/discharging.

12. The dual source LMHP method of claim 10, wherein said solar thermal panels collected heat continuously charging thermal energy storage while the Mode 2 operation of said heat pumping device charging thermal energy storage as needed, either as recharging thermal energy storage after its depletion for preventing heat pump starvation or as precharging thermal energy storage.

13. The method of claim 10, wherein aid precharging of thermal energy storage in the heating application further comprising electric resistance heating, in place of mode two heat pumping precharging, taking place during hours of excess grid output of electricity from variable renewable-sources.

14. The method of claim 8, wherein said TES device further comprising a smaller water heater (42) equipped with electric resistive element (44), the operation of which is controlled by a Grid Integrated Water Heater (GIWH) control unit (46).

15. The method of claim 8, wherein said building space is equipped with hydronic heat distribution network and each room space equipped with thermally activated radiant surfaces, otherwise known as thermally activated building systems (TABS).

16. The method of claim 14, further including a sensor-instrument of said thermal energy storage/water heater, and said building being equipped with sensor-instruments as well, data from which are entered into a modeling predictive control unit that determines, with sensor data combined with inputs of weather forecast, the extent of precharging the thermal energy storage for meeting anticipated building conditioning need.

17. The method of claim 16, wherein said modeling predictive control unit further being coordinated with building user behavior data and grid data including minute-to-minute utility rate schedule for both refining precharging/discharging operation and demand-response charging, respectively, and, with electric resistance element in said water heater, providing ancillary services to utility for voltage support and frequency regulation;
whereby LMHP operates as a multi-function, grid-interactive low-grade-heat managing method.

18. A method of managing-low-grade-heat for building cooling and refrigeration, comprising
a. providing exact heat extraction via the use of a device for heat pumping in two phases, first phase and second phase, enabled with a device for thermal energy storage (TES) of a predetermined heat capacity;
b. means for charging, or precooling, said thermal energy storage device with the operation of said heat pumping means in the second phase;
c. conditioning means for removing heat from a building space or refrigerated space by operating said heat pumping device in the first phase, in which the operation results in discharge in said thermal energy storage device's coolness;
whereby the alternate TES precooling and TES discharging in its coolness resulting in flexibility in the operating timing of the precooling phase and, at the same time, reduction in peak load demand facilitating demand-response for air-conditioning and refrigeration.

19. The method of claim 18, wherein the single function method is used for the single function of building space heating.

20. The method of claim 18, further including a sensor-instrument of thermal energy storage and said cooled-space/refrigerated-space being equipped with sensor-instruments as well as a modeling predictive control unit that determine, from the sensor-instruments inputs and weather forecast inputs, the extent of precooling the thermal energy storage for meeting anticipated air-conditioning/refrigeration need.

21. The method of claim 18, wherein said modeling predictive control unit being custom-tailored with utility rate schedule or independent power provider rate schedule.
